(19) United States
(12) Patent Application Publication
(10) Pub. No.: US 2025/0337239 A1
(43) Pub. Date: Oct. 30, 2025

(54) REMOTE SENSING FOR POWER GRID FUSE TRIPPING USING AI-BASED FIBER SENSING WITH AERIAL TELECOM CABLES

(71) Applicant: NEC Laboratories America, Inc., Princeton, NJ (US)

(72) Inventors: Zhuocheng JIANG, Plainsboro, NJ (US); Yue TIAN, Princeton, NJ (US); Wataru KOHNO, Princeton, NJ (US); Yangmin DING, East Brunswick, NJ (US); Sarper OZHARAR, Pennington, NJ (US); Ting WANG, West Windsor, NJ (US)

(73) Assignee: NEC Laboratories America, Inc., Princeton, NJ (US)

(21) Appl. No.: 19/190,315

(22) Filed: Apr. 25, 2025

Related U.S. Application Data
(60) Provisional application No. 63/638,442, filed on Apr. 25, 2024.

(51) Int. Cl. H02J 3/00; G01D 5/353; G01H 9/00

(52) U.S. Cl. CPC H02J 3/0012; G01D 5/35358; G01H 9/004; H02J 2203/20

(57) ABSTRACT

Disclosed are integrated DFOS/DAS systems, methods, and structures that advantageously detecting fuse cutoff blowing events using existing telecom cables. Our systems, methods, and structures employ an exciter to broadcast acoustic signal tracks and evaluated on wooden utility poles within a real-scale testbed, simulating fuse cutoff blowing events in the power grid. A Distributed Acoustic Sensing (DAS) system connected to an optical fiber sensor cable collects a 2D waterfall matrix. A frequency learning model is subsequently used to identify these acoustic events based on the results of frequency analysis.

### CROSS REFERENCE TO RELATED APPLICATIONS

This application claims the benefit of U.S. Provisional Patent Application Ser. No. 63/638,442 filed Apr. 25, 2024, the entire contents of which is incorporated by reference as if set forth at length herein.

### FIELD OF THE INVENTION

This application relates generally to infrastructure monitoring using distributed fiber optic sensing (DFOS). More particularly, it pertains to the remote sensing of power grid fuse tripping using artificial intelligence (AI) based fiber sensing with aerial telecom cables.

### BACKGROUND OF THE INVENTION

Distributed Acoustic Sensing (DAS) is a DFOS technology that uses fiber optic cables to detect acoustic vibrations. It has a wide range of applications due to its unique capabilities. Its ability to detect small vibrations over long distances in real-time makes it a valuable tool for monitoring and protecting infrastructures including electrical power grids.

In recent years, more frequent electrical power outages have occurred due—in part—to damage to electrical power equipment caused by increasing severe weather events, vehicle accidents, and wildlife. Importantly, research shows that electrical power outages exceeding eight (8) hours pose a great health hazard for people using electricity-dependent durable medical equipment (DME) and for those in under-resourced communities who require electrical power for refrigeration, heating, and/or cooling. However, timely repairs and restorations of electrical power outages remain challenging due to difficulties in localization of hazard(s) in a vast, paralyzed electrical power grid.

Meanwhile, electrical power outages oftentimes impact local telecommunications equipment, resulting in communication disruptions that further impede detection/restoration of electrical power disruptions that may be electric sensors transmitting data to a distant control center. As will be appreciated, remote, real-time detection and localization methods for over-current events and electrical power outages would represent a welcome addition to the art. can greatly help reduce manual survey efforts and shorten the power restoration time.

### SUMMARY OF THE INVENTION

An advance in the art is made according to aspects of the present disclosure directed to integrated DFOS/DAS systems, methods, and structures that advantageously—and in sharp contrast to the prior art—remotely monitor tripping events of pole-mounted fuse cutouts along electrical power lines.

Operationally our inventive systems and methods employ a frequency learning model to identify and localize fuse cutout blowing. As we shall describe, our experimental results show that our inventive approach and model achieves a detection accuracy greater than 98% on distributed acoustic sensing (DAS) data. As a result, our inventive systems and methods enable telecommunication carriers to utilize their existing, large-scale fiber networks for power outage sensing and fast restoration, benefiting carriers, utility companies, and their customers.

Finally, we demonstrate the operation of our inventive systems and methods using remote distributed fiber optic sensing/distributed acoustic sensing to detecting fuse cutoff blowing events using existing, optical fiber telecommunication cables. An exciter is utilized to broadcast acoustic signal tracks on wooden utility poles within a real-scale testbed, simulating fuse cutoff blowing events in an electrical power grid. A distributed acoustic sensing (DAS) system utilizing the optical fiber telecom cable as a sensor collects a 2D waterfall matrix. A frequency learning model is then used to identify acoustic events of interest based on the results of frequency analysis.

### BRIEF DESCRIPTION OF THE DRAWING

FIG. 1(A) and FIG. 1(B) are schematic diagrams showing an illustrative prior art uncoded and coded DFOS systems.

FIG. 2 shows an illustrative overall testbed setup schematic for evaluation experiments according to aspects of the present disclosure.

FIG. 3(A) shows a field setup for data collection experiments and FIG. 3(B) is a waterfall plot and extracted 1D time series data for the illustrative experiments according to aspects of the present disclosure.

FIG. 3(A) and FIG. is a schematic diagram showing illustrative implementation details of our inventive systems, methods, and structures according to aspects of the present disclosure.

FIG. 4(A) and FIG. 4(B) are plots of short-time Fourier transform of: FIG. 4(A) frequency sweep source signal; and FIG. 4(B) recorded DAS signal from optical fiber sensor cable located near speaker according to aspects of the present disclosure.

FIG. 5 shows a plot of frequency spectrum comparison of four vibration events evaluated in our experiment according to aspects of the present invention.

FIG. 6 shows a schematic block diagram of a 1D frequency response learning model for acoustic event recognition according to aspects of the present invention.

FIG. 7 shows a confusion matrix for the trained model's performance on test dataset according to aspects of the present disclosure.

FIG. 8 shows recognition performance on collected dataset according to aspects of the present disclosure.

FIG. 9 is a schematic diagram showing an illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

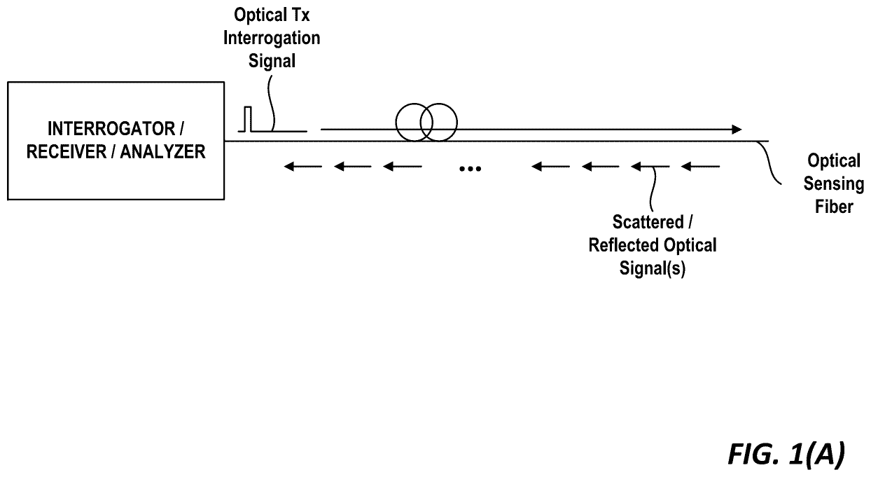

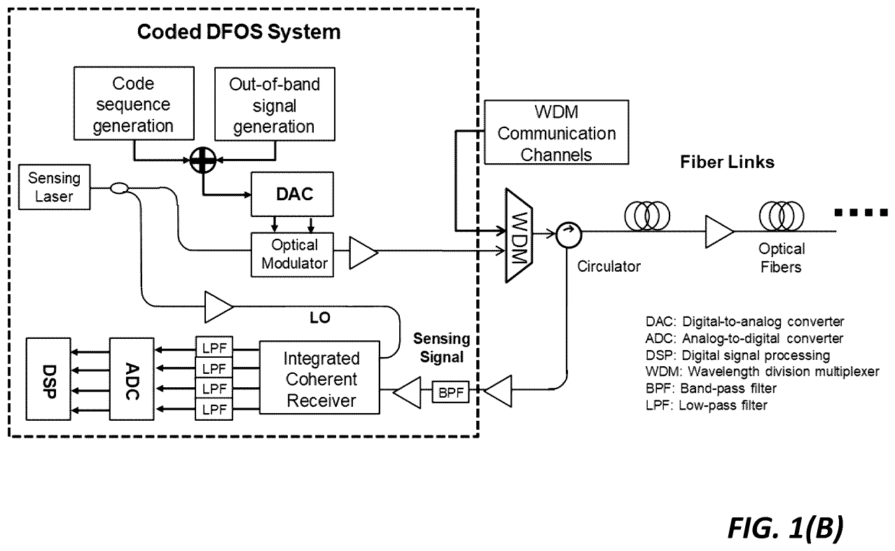

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS/DAS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

According to aspects of the present disclosure, we introduce an innovative Distributed Fiber Optic Sensing (DFOS) technology that advantageously utilizes existing telecommunications infrastructure networks. DFOS enables a novel approach to monitor electrical power grid operations including power grid fuse tripping using AI-based DFOS on aerial telecom cables.

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

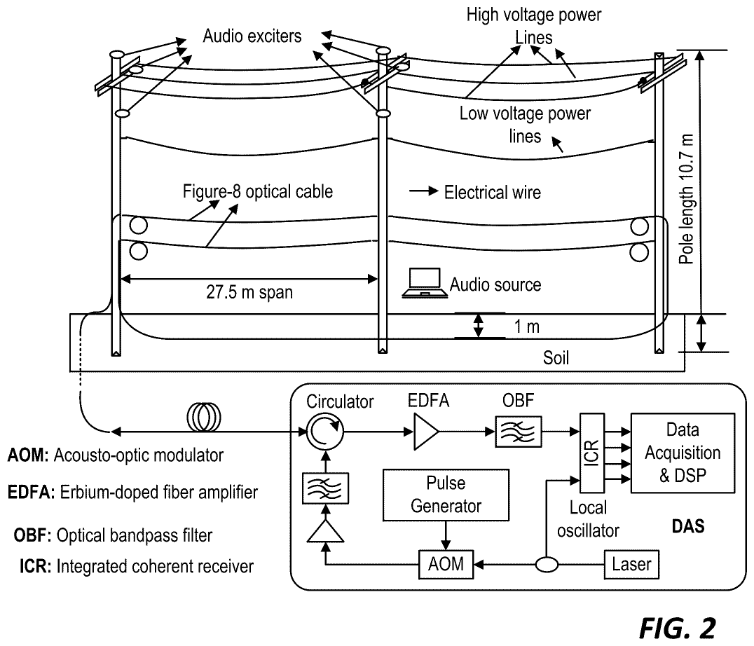

FIG. 2 shows an illustrative overall testbed setup schematic for evaluation experiments according to aspects of the present disclosure.

As shown in FIG. 2, our testbed includes three type-Il wooden utility poles, which are broadly used in distribution grids in the United States and other countries. A FIG.-8 self-supporting cable hosting 36 single mode fiber (G652D) cores in 6 loose tubes was deployed at the lower layer and aerially suspended by three poles for two rounds. Dummy power lines were installed at the top and middle levels to demonstrate a typical power distribution setup. On each pole, three 25-Watt audio exciters nested in weather-proof housings were installed at the top (Exciter 1), at the crossarm (Exciter 2) and on the body around 1 m below the crossarm (Exciter 3) respectively. They were driven by an audio source to emulate various acoustic and vibration events at different locations on the poles.

As illustrated in FIG. 2, a coherent-detection-based DAS system was connected to one core of this 1-km long fiber cable for data collection. In the DAS system, an acousto-optic modulator (AOM) is utilized to create optical pulses with 40-ns width to sample the fiber strain changes. The full polarization and phase information recovered by coherent detection greatly reduces the chance of polarization fading. The DAS was configured with a pulse repetition rate of 20 kHz, and a gauge length of 4.08 meters, and had a noise floor of 43 pε/\sqrt{Hz} at 1 km away

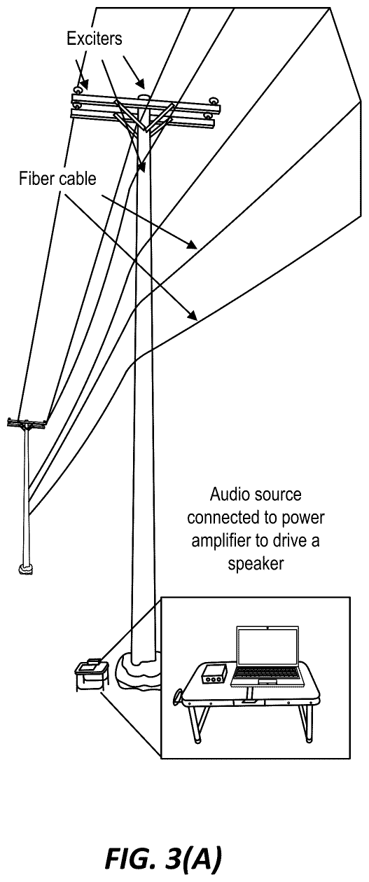

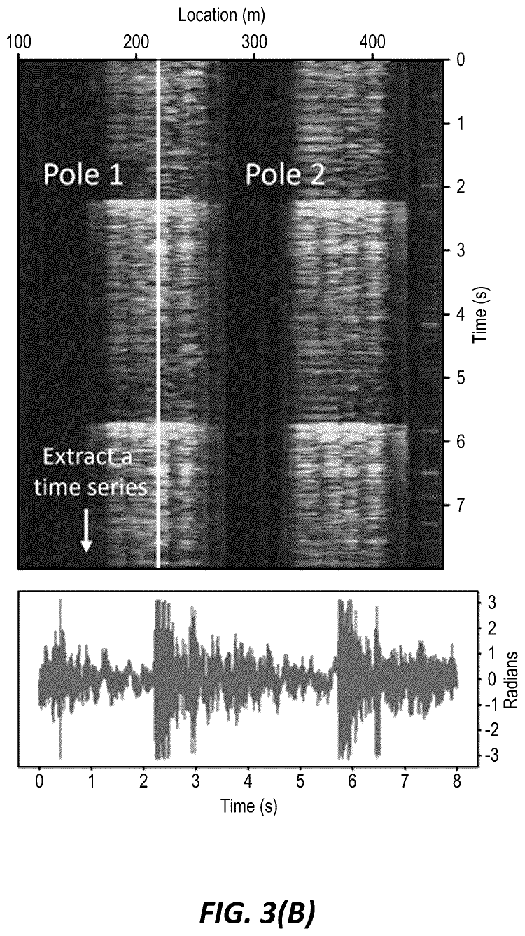

FIG. 3(A) shows a field setup for data collection experiments and FIG. 3(B) is a waterfall plot and extracted 1D time series data for the illustrative experiments according to aspects of the present disclosure.

### Data Collection

We emulated fuse cutout blowing events as well as three other comparable events that produce similar impulse vibration profiles and designed a machine learning model to distinguish fuse cutout blowing from other false events. We utilized the pole-mounted exciters to play real-world recordings of fuse cutoff blowing, transformer explosions and gunshots. In addition, we also mechanically impacted (knocked) the pole with a hammer to generate impulse vibrations directly.

FIG. 3(A) illustrates the field setup of our data collection experiments, showing the audio source connected to an exciter through an audio amplifier. As shown in the figure, the DAS system measures optical phase differences between every adjacent location pair separated by the gauge length along the fiber cable, forming a 2D spatio-temporal data matrix, or waterfall plot as shown in FIG. 3(B). Each column in this waterfall plot represents the time series data at the corresponding location. Therefore, the rich information enables simultaneous monitoring of acoustic or vibration events at every location on the cable. In this study, we refined the 2D waterfall data by extracting time series from specific locations along the fiber cable. To diversify our dataset, we conducted experiments using three exciters at two of the three poles, under varying environmental conditions including sunny, windy and rainy conditions

### Data Analysis and Machine Learning Model

We now present and describe a detailed analysis of collected waterfall data and describe the development of a machine learning model that leverages these insights to advance our objectives. Based on the domain knowledge that different vibration and acoustic events exhibit distinct frequency responses, these characteristics should be utilized as key features to differentiate between these events. However, in practical applications, the frequency response of the collected DAS data often differs from the acoustic source. This distortion can be attributed to non-uniform and nonlinear response of the complex exciter-pole-cable system during coupling and transmission in multiple media with different physical properties. Considering that such interference could degrade the performance of acoustic event identification, we experimentally investigated the frequency response profile of our testbed as the first step.

In this experiment, we played a frequency sweep signal with constant amplitude sweeping from 0 to 2000 Hz in 40 seconds and used the DAS to collect the vibration data generated by this sweep. The short-time Fourier transform result of the DAS data showed much larger attenuation by the exciterpole-cable system at higher frequencies than lower ones. Therefore, we plotted the result of a subrange from 0 to 500 Hz to focus on the lower frequencies that carry most of the energy.

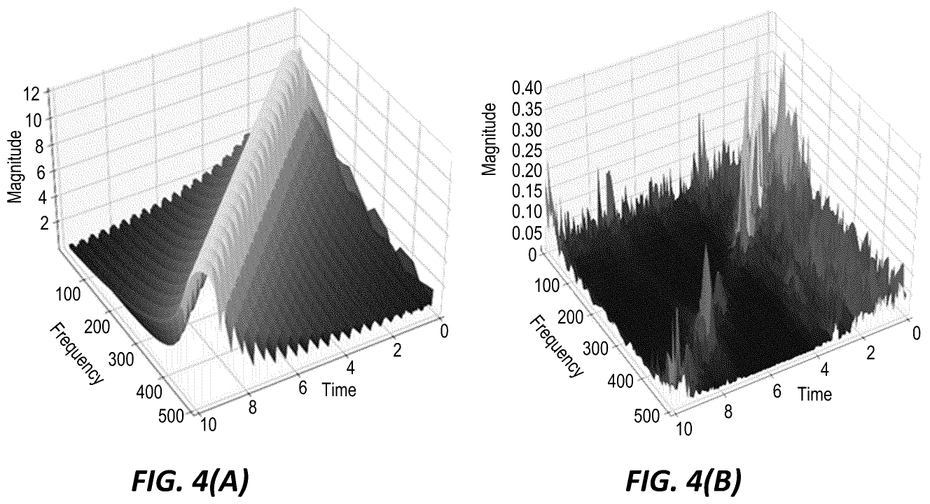

FIG. 4(A) and FIG. 4(B) are plots of short-time Fourier transform of: FIG. 4(A) frequency sweep source signal; and FIG. 4(B) recorded DAS signal from optical fiber sensor cable located near speaker according to aspects of the present disclosure.

As shown in FIG. 4(A), the frequency sweep signal features a distinct pattern, where the frequency progressively increases to 500 Hz over 10 seconds. FIG. 4(B) shows the frequency response of the recorded DAS from fiber cable near the exciter. We observed a clear frequency shifting pattern consistent with the sweep source signal, demonstrating the exciter-pole-cable system coupling the vibration from the exciter to the cable in this range. When the sweeping signal frequency was around and below 150 Hz during the first 3 seconds of sweep, multiple source frequency values triggered broadband and strong nonlinear responses.

These frequency values are believed to be associated with the exciter-pole-cable system's resonance frequencies, where the vibrational energy from the exciter were more efficiently absorbed by the system and triggered much stronger vibrations and harmonic frequencies. The weak frequency responses, when source frequency is sweeping around 250 Hz (at 5 seconds time), are likely due to the attenuation of vibration wave propagating in the media and the filtering effect of the coupling between the components in the system, e.g., from exciter to pole, from pole to cable. These observations provide valuable insights that one should focus on the low-frequency range for feature extraction and learning.

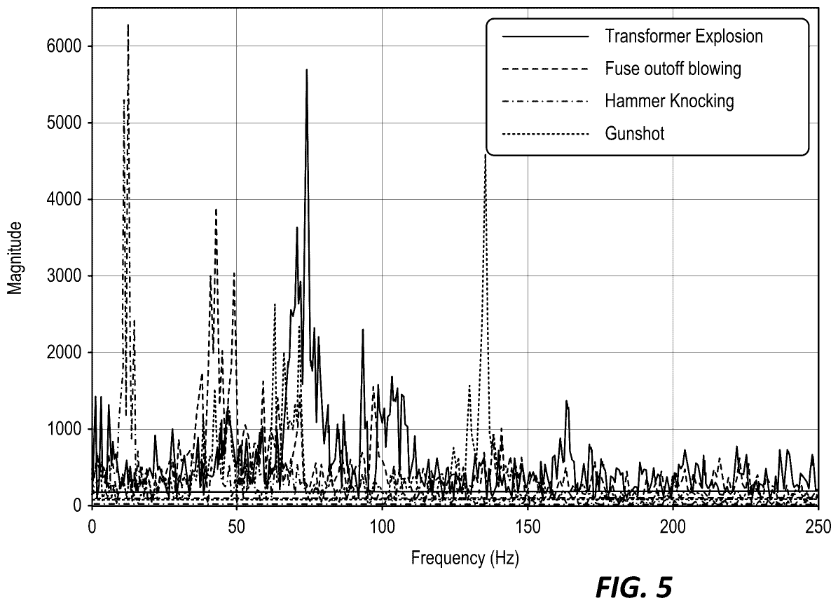

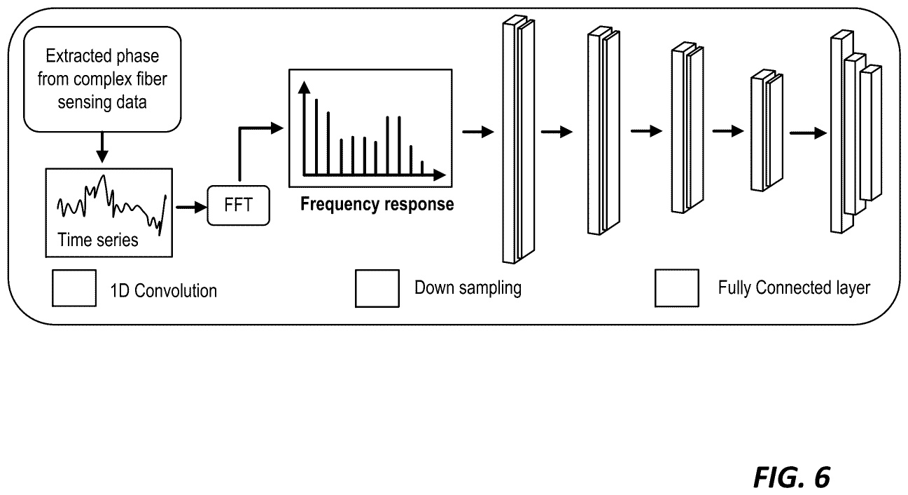

FIG. 5 shows a plot of frequency spectrum comparison of four vibration events evaluated in our experiment according to aspects of the present invention.

As shown, FIG. 5 presents the frequency analysis of the four selected vibration events, illustrating that each event has its unique frequency range distinct from the others. As shown in the figure, each event exhibits distinct frequency characteristics: hammer knocking predominantly features low-frequency components below 25 Hz; the fuse cutout blowing event is characterized by unique frequencies around 50 Hz; the transformer explosion shows a strong impulse response near 80 Hz. Meanwhile, the gunshot event, despite sharing some frequencies with the fuse cutout and transformer explosions, distinctly includes frequencies at around 130 Hz

Based on the distinct frequencies observed, we developed a frequency learning model for identifying acoustic events. Unlike traditional time series data classification, which operates in the time domain, our model works within the latent space of frequency features. This approach allows us to leverage the unique frequency signatures of each event more effectively. FIG. 5 illustrates the structure of the machine learning model. We perform a signal preprocessing first to obtain the phase difference from the raw collected DAS data.

Subsequently, a Fast Fourier Transform (FFT) is applied to the time series data before it is fed into 1D convolutional layers for nonlinear feature learning. In the end, three fully connected layers are attached to derive the probability of classification. Note that we employed a simplified network structure, incorporating just four convolutional operations, to facilitate real-time detection of acoustic events. This streamlined approach ensures efficient processing while maintaining effective performance.

### Results and Discussion

The model is trained on a dataset consisting of approximately 40,000 time series, each exhibiting a 2,000 sequence length, extracted from DAS-captured acoustic events. We employ a cross-entropy loss function and an Adam optimizer with a learning rate of 0.001 to optimize training efficiency and accuracy.

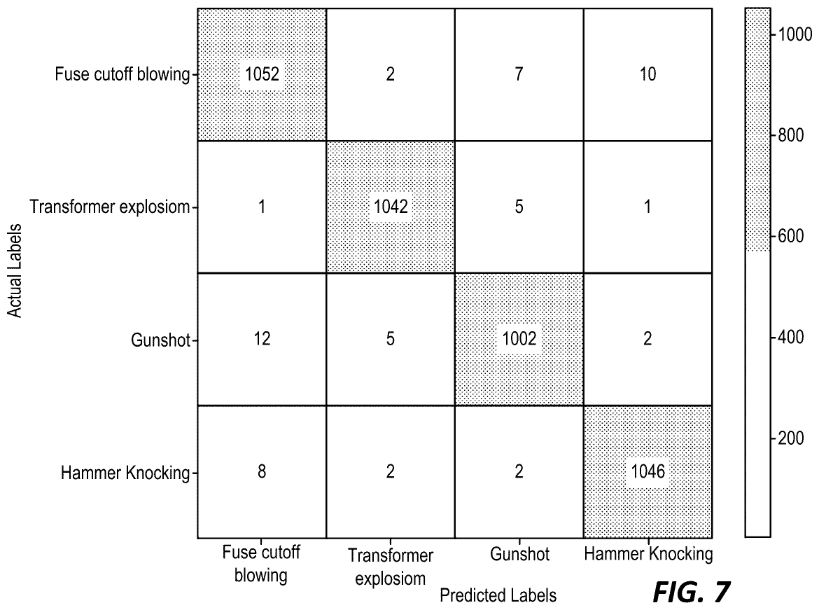

FIG. 7 shows a confusion matrix for the trained model's performance on test dataset according to aspects of the present disclosure. As compared to transformer explosions, the categories for gunshot and hammer knocking exhibit the most classification errors.

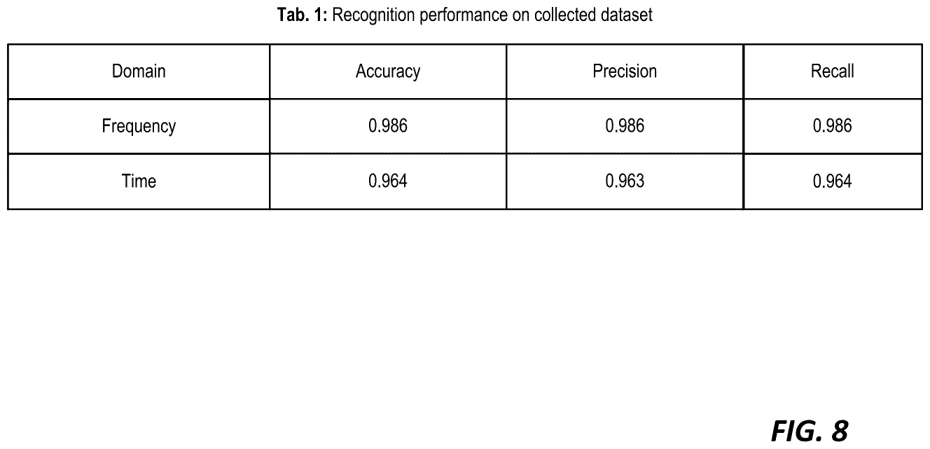

FIG. 8 presents in tabular form classification accuracy of the trained model on a test dataset, which includes over 4,000 samples. Notably, this dataset features data collected under windy and rainy weather conditions—scenarios not covered in the training dataset. The testing accuracy surpassing 98% demonstrates the model's robustness, even with domain shifts. Furthermore, our frequency-learning model slightly outperforms the time-domain learning model using the same structural framework. This observation aligns well with our previous frequency analysis, underscoring the effectiveness of focusing on frequency features.

Conclusions This paper demonstrates a remote fiber sensing solution for detecting fuse cutoff blowing events using existing telecom cables. We employ an exciter to broadcast acoustic signal tracks on wooden utility poles within a real-scale testbed, simulating fuse cutoff blowing events in the power grid. A Distributed Acoustic Sensing (DAS) system connected to the fiber cable collects the 2D waterfall matrix. We then develop a frequency learning model to identify these acoustic events based on the results of frequency analysis.

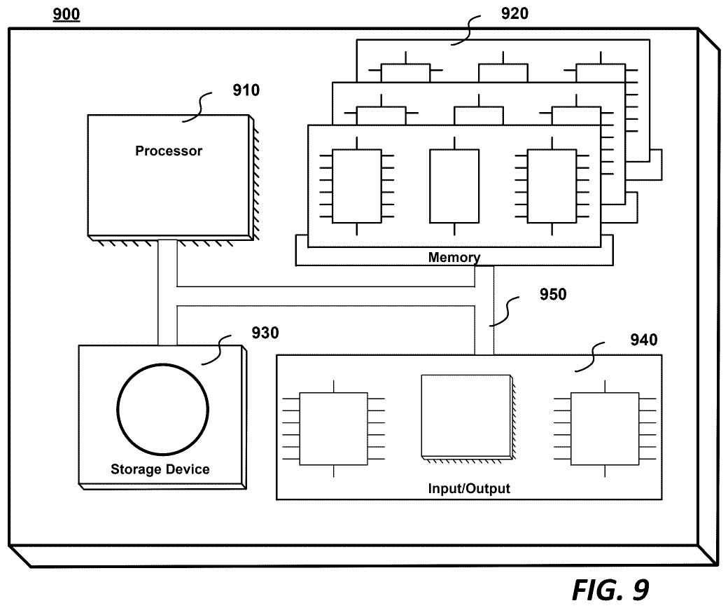

FIG. 9 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 900 as stored program control instructions.

Computer system 900 includes processor 910, memory 920, storage device 930, and input/output structure 940. One or more input/output devices may include a display 945. One or more busses 950 typically interconnect the components, 910, 920, 930, and 940. Processor 910 may be a single or multi core. Additionally, the system may include accelerators etc., further comprising the system on a chip.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 830 may be a flash memory device, a disk drive, an optical disk device, or a tape device employing magnetic, optical, or other recording technologies.

Input/output structures 940 may provide input/output operations for system 900.

At this point, those skilled in the art will understand and appreciate that we have demonstrated a remote fiber sensing solution for detecting fuse cutoff blowing events using existing telecom cables. We employ an exciter to broadcast acoustic signal tracks on wooden utility poles within a real-scale testbed, simulating fuse cutoff blowing events in the power grid. A Distributed Acoustic Sensing (DAS) system connected to the fiber cable collects the 2D waterfall matrix. We then develop a frequency learning model to identify these acoustic events based on the results of frequency analysis.

While we have presented our inventive concepts and description using specific examples, our invention is not so limited. Accordingly, the scope of our invention should be considered in view of the following claims.

1. A distributed acoustic sensing (DAS) method comprising:
collecting, using a DAS system, backscatter data from an optical sensing fiber;
generating, 2D waterfall matrices from the collected backscatter data;
developing, a frequency learning model to identify different acoustic events; and
determining, using the frequency learning model, different acoustic events acoustically affecting.

2. The method of claim 1 wherein at least one of the determined acoustic events is a fuse tripping event occurring on an electrical power facility.

3. The method of claim 2 wherein at least one of determined acoustic events is a transformer malfunction event.

4. The method of claim 3 wherein the optical sensing fiber is suspended aerially on a plurality of utility poles and at least one of the determined acoustic events is a gunshot.

5. The method of claim 2 wherein the DAS system is a coherent detection-based DAS system.

6. The method of claim 5 further comprising:
training, the frequency learning model using simulated fuse tripping events.

7. The method of claim 6 wherein the simulated fuse tripping events are performed by pole-mounted exciters.

8. The method of claim 5 wherein frequency response of collected DAS data differs from its acoustic source.

9. The method of claim 6 wherein the at least one determined acoustic event is determined by a 1D frequency response model.

10. The method of claim 9 wherein the 1D frequency response model receives as input an extracted phase from complex fiber sensing data, performs a Fast Fourier Transform on a time series of that complex fiber sensing data generating a frequency response and applies the frequency response to a succession of 1D convolutional layers for nonlinear feature learning and fully connected layers to derive probabilities of classification.
